(19) United States
(12) Patent Application Publication
(10) Pub. No.: US 2012/0017184 A1
(43) Pub. Date: Jan. 19, 2012

(54) SYSTEM FOR CREATING LAYOUT PATTERN FOR MANUFACTURING MASK ROM, MASK ROM MANUFACTURED USING THE SYSTEM, AND METHOD FOR CREATING MASK PATTERN

(76) Inventors: Michiko Tsukamoto, Kanagawa (JP); Takashi Nakajima, Kanagawa (JP); Atsushi Miyanishi, Kanagawa (JP)

(21) Appl. No.: 13/259,825

(22) PCT Filed: Apr. 15, 2009
(86) PCT No.: PCT/JP2009/057565

§ 371 Date: Sep. 23, 2011

(51) Int. Cl. G06F 17/50

(52) U.S. Cl. 716/55

(57) ABSTRACT

When generating a temporary ROM code file and a design information file, a host server generates a dedicated ROM compiler and an intermediate file associated with the dedicated ROM compiler. In a workstation, the dedicated ROM compiler is executed, whereby the contents of a design information file are changed to the contents corresponding to a correct ROM code. The dedicated ROM compiler is specifically designed to be capable of changing only a particular design parameter and the design information file associated with the temporary ROM code file.

### TECHNICAL FIELD

The present invention relates to a system for creating a layout pattern for manufacturing a mask ROM, a mask ROM manufactured using the system, and a method for creating a layout pattern.

### BACKGROUND ART

A mask ROM (Read Only Memory) has been conventionally known as a device storing information in a nonvolatile manner. The foregoing mask ROM stores particular information (also referred to as “ROM code” hereinafter) by forming a predetermined circuit pattern on a semiconductor. The foregoing mask ROM is typically manufactured by performing exposure processing on a semiconductor substrate using a photomask having the circuit pattern described thereon. Therefore, it is necessary to efficiently create such a circuit pattern (also referred to as “layout pattern” hereinafter) to be drawn on the photomask.

As the prior art of creating a layout pattern for such a mask ROM, Japanese Patent Laying-Open No. 06-215070 (Patent Literature 1), Japanese Patent Laying-Open No. 06-139309 (Patent Literature 2), Japanese Patent Laying-Open No. 05-189521 (Patent Literature 3) and the like have been known.

As the information communication technology rapidly advances, shortening the development period of such a mask ROM, that is, shortening TAT (Turn Around Time) has also been especially demanded in recent years. On the other hand, in the development process of a product on which the mask ROM is implemented, an ROM code to be stored in the mask ROM is frequently changed in many cases.

### CITATION LIST

### PTL 1: Japanese Patent Laying-Open No. 06-215070

### PTL 2: Japanese Patent Laying-Open No. 06-139309

### PTL 3: Japanese Patent Laying-Open No. 05-189521

### SUMMARY OF INVENTION

### Technical Problem

In a conventional system for creating a layout pattern, a job of re-creating all layout patterns has been needed every time an ROM code is changed. It should be noted that as for a particular mask ROM, the use of a layout pattern generating device disclosed in aforementioned Japanese Patent Laying-Open No. 05-189521 (Patent Literature 3) may lead to shortening the TAT in some cases. However, in an SOC (Silicon On a Chip) and the like having a processor and a memory mounted on the same semiconductor substrate, the position itself where the mask ROM is placed is frequently changed, and thus, the layout pattern generating device disclosed in Japanese Patent Laying-Open No. 05-189521 (Patent Literature 3) has not been applicable as it is.

In addition, from the viewpoint of information security, a demand to maintain confidentiality of the ROM code has also been increased in recent years. Thus, a process of designing and developing a device using a provisional ROM code different from an actual ROM code, and then, changing the provisional ROM code to the actual ROM code and determining the layout pattern in a final step has been employed in many cases.

The conventional system for creating a layout pattern has not, however, been able to be sufficiently adapted to the process as described above.

The present invention has been made to solve the above problems, and an object of the present invention is to provide a system capable of creating a layout pattern for a mask ROM while maintaining confidentiality of a code to be stored in the mask ROM. In addition, another object of the present invention is to provide a mask ROM manufactured using the foregoing system. Furthermore, still another object of the present invention is to provide a method for creating a layout pattern capable of creating a layout pattern for a mask ROM while maintaining confidentiality of a code to be stored in the mask ROM.

### Solution to Problem

According to an aspect of the present invention, there is provided a system for creating a layout pattern for manufacturing a mask ROM. The system includes a first information processing device and a second information processing device. The first information processing device includes: a module for accepting a design parameter for the mask ROM to be manufactured; and a module for generating a first code. The first code is determined independently of a second code stored in the mask ROM to be manufactured. The system further includes: a module for generating first design information corresponding to the first code; and a module for outputting a program file having a command stored therein. The program file includes identification information indicating association of the program file with the first code and the first design information. The second information processing device is configured, when executing the command stored in the program file, to include: a module for accepting the second code; a module for generating second design information corresponding to the second code, based on the first code and the first design information; and a module for prohibiting generation of the second design information when the first code and the first design information associated with the program file are not present based on the identification information.

Preferably, the module for generating the first code is adapted to determine the first code randomly.

Preferably, the first information processing device and the second information processing device are connected via a network to allow data communication. The first information processing device delivers the first code, the first design information and the program file to the second information processing device via the network.

According to another aspect of the present invention, there is provided a mask ROM manufactured using the above system.

According to still another aspect of the present invention, there is provided a method for creating a layout pattern for manufacturing a mask ROM using a system including a first information processing device and a second information processing device. The method includes the steps of: by the first information processing device, accepting a design parameter for the mask ROM to be manufactured; and by the first information processing device, generating a first code. The first code is determined independently of a second code stored in the mask ROM to be manufactured. The method further includes the steps of: by the first information processing device, generating first design information corresponding to the first code; and by the first information processing device, outputting a program file having a command stored therein. The program file includes identification information indicating association of the program file with the first code and the first design information. The method further includes the steps of: by the second information processing device, executing the command stored in the program file; by the second information processing device, accepting the second code; by the second information processing device, generating second design information corresponding to the second code, based on the first code and the first design information; and by the second information processing device, prohibiting generation of the second design information when the first code and the first design information associated with the program file are not present based on the identification information.

### ADVANTAGEOUS EFFECTS OF INVENTION

According to the present invention, the layout pattern for the mask ROM can be created while maintaining confidentiality of the code to be stored in the mask ROM.

### BRIEF DESCRIPTION OF DRAWINGS

FIG. 1 is a schematic diagram showing a general product design flow according to an embodiment of the present invention.

FIG. 2 shows a schematic configuration of a system according to the embodiment of the present invention.

FIG. 3 is a schematic configuration diagram showing a hardware configuration of a host server and a workstation shown in FIG. 2.

FIG. 4 is a diagram for describing an overview of processing in the system according to the embodiment of the present invention.

FIG. 5 is a functional block diagram of the host server according to the embodiment of the present invention.

FIG. 6 is a functional block diagram of the workstation according to the embodiment of the present invention.

FIG. 7 is a flowchart showing a processing procedure in the system according to the embodiment of the present invention.

### DESCRIPTION OF EMBODIMENTS

An embodiment of the present invention will be described in detail with reference to the drawings, in which the same or corresponding portions are denoted with the same reference characters, and description thereof will not be repeated.

### <Product Design Flow>

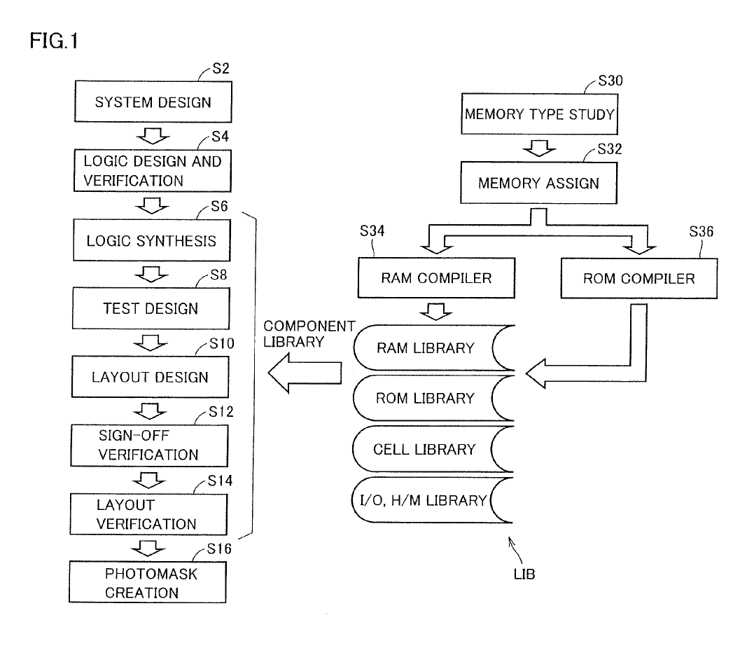

Before describing a system for creating a layout pattern for manufacturing a mask ROM according to the present embodiment, a general product design flow including a semiconductor chip will be first described in order to facilitate understanding of its positioning. It should be noted that the product design flow shown in FIG. 1 describes a processing procedure when a chip manufacturer designs and develops a series of semiconductor chips including a mask ROM, in response to a demand for a particular semiconductor chip from a customer.

FIG. 1 is a schematic diagram showing the general product design flow according to the embodiment of the present invention. Referring to FIG. 1, the customer first carries out system design of the entire product including a semiconductor chip of interest (step S2). More specifically, the contents of input/output data, the contents of logic or the like are determined.

When this system design is completed, the customer or the chip manufacturer carries out logic design and verification (step S4). This step is also referred to as “Register Transfer Level (RTL),” in which a circuit operation in the semiconductor chip of interest is designed by paying attention to transmission and reception of data between a hardware register and a Boolean logic circuit. Then, the chip manufacturer carries out logic synthesis for combining a plurality of logic designs into one semiconductor chip (step S6).

Then, the chip manufacturer carries out test design corresponding to the logic synthesized in step S6 (step S8). More specifically, a test pattern having a higher fault detection rate is designed using a scan technique, a BIST (Built In Self-Test) technique or the like. Then, the chip manufacturer carries out layout design for determining a layout on a substrate (step S10).

When a series of designs as described above is completed, the chip manufacturer carries out sign-off verification (step S12). In this sign-off verification, a final logic function and timing are verified. Typically, Static Timing Analysis (STA), Signal Integrity Analysis, actual load simulation and the like are used for this sign-off verification.

When the sign-off verification is completed, the chip manufacturer carries out layout verification (step S14). In this layout verification, a layout pattern of a mask is verified. Typically, in this layout verification, DRC (Design Rule Checking) verification and LVS (Layout Versus Schematic) are carried out. In the DRC verification, it is verified whether or not a geometric design rule determined by constraints of a manufacturing apparatus is satisfied. In the LVS verification, it is verified whether or not the logic design, and an element and electrical connection between the elements created in the circuit design stage are correctly implemented in the layout design.

After the verification steps as described above, an actual photomask is created (step S16).

Steps S2 to S14 as described above are implemented on a computer. In steps S6 to S14 of these steps, various types of processing are performed by sequentially referring to a component library LIB prepared in advance. This component library LIB includes an RAM (Random Access Memory) library and an ROM library as libraries related to a memory.

In a design procedure related to the foregoing memory, the customer or the chip manufacturer first studies the memory type (step S30). Then, the customer or the chip manufacturer carries out memory assign for determining the capacity and the like for each type of memory required (step S32). Then, the customer or the chip manufacturer generates the RAM library and the ROM library using an RAM compiler and an ROM compiler, respectively, based on the determined design parameter (steps S34 and S36).

### <Overview>

The system for creating the layout pattern for manufacturing the mask ROM according to the present embodiment is mainly designed for processing related to the ROM library in step S36 shown in FIG. 1. More specifically, in the system according to the present embodiment, in order to respond to a demand and the like to enhance confidentiality of an ROM code owned by the customer, the sign-off verification (step S12 shown in FIG. 1) and the layout verification (step S14 shown in FIG. 1) by the chip manufacturer are carried out using a provisional ROM code (also referred to as “temporary ROM code” hereinafter), and the temporary ROM code is changed to an actual ROM code (also referred to as “correct ROM code” hereinafter) owned by the customer, when the series of designs and verifications are completed. Then, based on information designed on the basis of this changed ROM code, the photomask is created.

With such a configuration, the capability to secure information of the correct ROM code can be strengthened for a person other than the customer. Furthermore, even when the ROM code is changed, it is unnecessary to perform again the already-performed steps in the product design flow, and thus, the TAT due to code change can be shortened.

### <System Configuration>

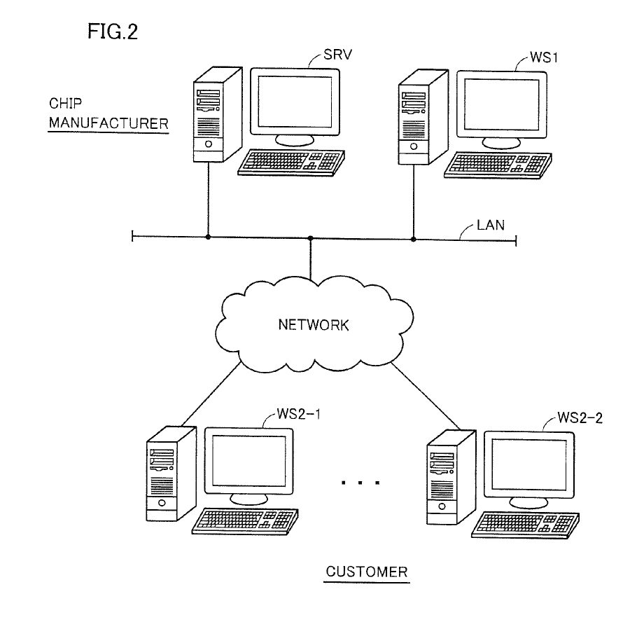

FIG. 2 shows a schematic configuration of the system according to the embodiment of the present invention. Referring to FIG. 2, the system according to the present embodiment typically includes a host server SRV and a workstation WS 1 provided on the chip manufacturer side, and workstations WS2-1, WS2-2, . . . provided on the customer side. Host server SRV and workstations WS1, WS2-1, WS2-2, . . . (also collectively referred to as “workstation WS” hereinafter) are information processing devices connected to one another to allow data communication. It should be noted that host server SRV and workstation WS1 are typically connected to allow data communication via an intra-company LAN, and host server SRV and workstations WS2-1, WS2-2, . . . are typically connected to allow data communication via a network NW such as Internet. It is envisioned that each of workstations WS2-1, WS2-2, . . . is provided on the customer side independent of one another. Alternatively, in the case where the chip manufacturer itself directly manufactures and sells products and the like including the semiconductor chip, for example, workstation WS does not need to be present on the customer side.

### <Hardware Configuration>

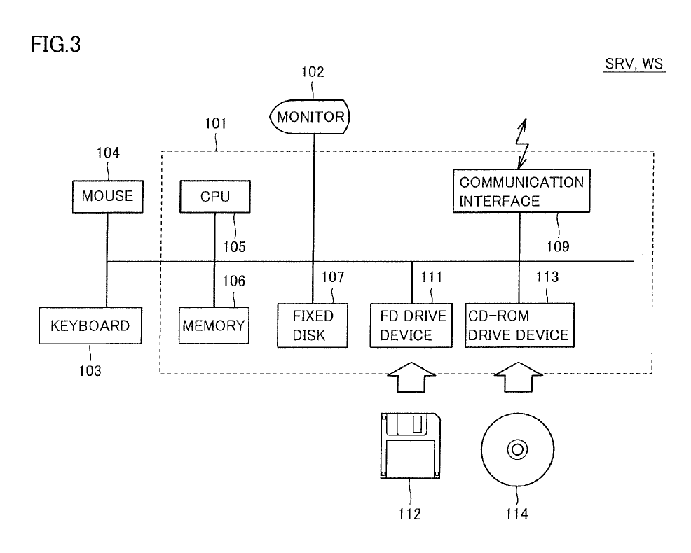

FIG. 3 is a schematic configuration diagram showing a hardware configuration of host server SRV and workstation WS shown in FIG. 2. Although FIG. 3 shows such a configuration that host server SRV and workstation WS are implemented by general-purpose computers, dedicated hardware may be used.

Referring to FIG. 3, host server SRV includes a main body unit 101, a monitor 102 serving as a display unit, and a keyboard 103 and a mouse 104 serving as input units. Monitor 102, keyboard 103 and mouse 104 are connected to main body unit 101.

Main body unit 101 includes a CPU (Central Processing Unit) 105 serving as a processor, a memory 106 and a fixed disk 107 serving as storage units, a communication interface 109, and an FD (Flexible Disk) drive device 111 and a CD-ROM (Compact Disk-Read Only Memory) drive device 113 serving as data reading devices. These units are mutually connected via a bus.

Typically, in host server SRV, CPU 105 executes a program by using computer hardware such as memory 106, whereby various types of functions as described below are provided. Generally, such a program is stored in a storage medium such as an FD 112 and a CD-ROM 114 and is distributed, or is distributed via the network and the like. Such a program is read from the storage medium by FD drive device 111, CD-ROM drive device 113 and the like, or is received by communication interface 109, and is stored in fixed disk 107. Furthermore, such a program is read from fixed disk 107 to memory 106, and is executed by CPU 105.

It should be noted that in some cases, CPU 105 may call a necessary module of program modules provided as a part of the operating system (OS) of the computer in a predetermined array and/or at a predetermined timing, and perform the processing, thereby implementing all or part of the function provided by host server SRV. In such a case, the program itself according to the present invention does not include the aforementioned module. Alternatively, the program according to the present invention includes a command for using the aforementioned module provided by the OS.

CPU 105 is a processor making various types of numerical logical operations, and performs processing as described below by executing a programmed command in sequence. Memory 106 stores various types of information in accordance with program execution by CPU 105.

Monitor 102 displays various types of information outputted by CPU 105. By way of example, monitor 102 is formed of an LCD (Liquid Crystal Display), a CRT (Cathode Ray Tube) or the like.

Mouse 104 accepts an instruction corresponding to an operation such as click or slide from the user. Keyboard 103 accepts an instruction corresponding to an inputted key from the user.

Communication interface 109 carries out data communication with workstation WS, another host server SRV or the like.

Since a hardware configuration of workstation WS is similar to that of host server SRV, detailed description thereof will not be repeated.

### <Overall Functional Configuration>

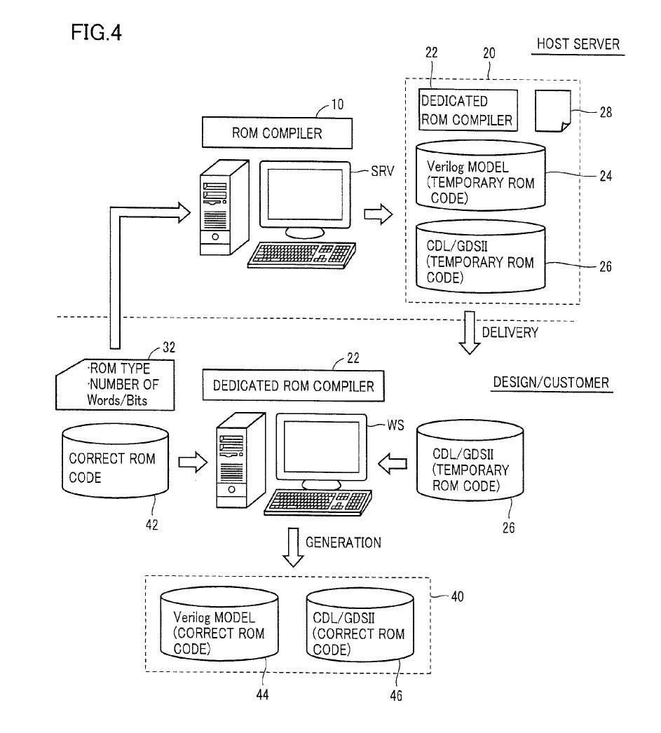

FIG. 4 is a diagram for describing an overview of processing in the system according to the embodiment of the present invention. It should be noted that FIG. 4 shows by way of example the case where a design department of the chip manufacturer and the customer are both involved in design and development.

Referring to FIG. 4, host server SRV first accepts a design parameter 32 for a mask ROM to be manufactured. In other words, the customer informs host server SRV (the chip manufacturer) of (1) the ROM type (kind), (2) the number of Words/Bits and the like of the mask ROM required by the customer. An ROM compiler 10 is installed on host server SRV in an executable manner. By executing this ROM compiler 10, a temporary ROM code file 24 is generated based on inputted design parameter 32. A temporary ROM code determined independently of an ROM code (correct ROM code) to be stored in the mask ROM by the customer is stored in this temporary ROM code file 24. This temporary ROM code is preferably determined randomly. This aims at improving the verification coverage in sign-off verification and layout verification. In other words, if a bit sequence formed of consecutive “0” or “1” is generated as the temporary ROM code, errors in logic design, errors in layout, errors in circuit connection and the like cannot be detected in some cases.

More specifically, if the temporary ROM code is formed of all “0” or “1,” there is no difference between results outputted from different addresses and thus the verification coverage cannot be improved. By randomly setting the temporary ROM code in order to address the above, the verification coverage can be improved because expected values of outputs from different addresses are different from each other.

In addition, if the temporary ROM code is formed of all “0” or “1,” layouts corresponding to the ROM code become uniform (only a layout that has contact or only a layout that does not have contact). Therefore, errors in layout cannot be detected in some cases by using a combination of the presence or absence of contact. By randomly setting the temporary ROM code in order to address the above, a probability of detection of errors in layout can be increased because combinations of layouts become diversified.

Similarly, if the temporary ROM code is formed of all “0” or “1,” netlists become uniform. Therefore, errors in circuit connection cannot be detected in some cases. By randomly setting the temporary ROM code in order to address the above, a probability of detection of errors in circuit connection can be increased because netlists become diversified.

It should be noted that this temporary ROM code is typically described by a hardware description language (Verilog HDL) used in a logic simulator (“Verilog model” shown in FIG. 4). An example of the contents of this temporary ROM code file 24 is as follows:

//BRMA24P2: 8 bits, 1024 words

@0 FE

@1 AE

@2 BB . . .

In the first line of the above description, the module name, the number of Bits and the number of Words provided to temporary ROM code file 24 are defined. In the second and subsequent lines, a numeral after “@” indicates the address on the mask ROM to be stored, and a further subsequent description such as “FE” indicates the mask ROM code to be stored.

Host server SRV also generates a design information file 26 corresponding to the generated temporary ROM code. This design information file 26 includes circuit design data (CDL: Circuit Design language) in which the electrical connection state of the elements is described, and layout design data (GDSII: Graphical Data system II) in which the geometric position of the elements is described.

Furthermore, when generating temporary ROM code file 24 and design information file 26 as described above, host server SRV generates a dedicated ROM compiler 22 and an intermediate file 28 associated with dedicated ROM compiler 22. As described later, this dedicated ROM compiler 22 is one type of program for generating a correct ROM code file 44 and a design information file 46 corresponding to the correct ROM code on workstation WS. In addition, intermediate file 28 indicates association of corresponding dedicated ROM compiler 22 with temporary ROM code file 24 and design information file 26 that are generated simultaneously with the corresponding dedicated ROM compiler 22. In other words, identification information included in intermediate file 28 is used to limit the range where dedicated ROM compiler 22 can change the contents when being executed on workstation WS, only to particular temporary ROM code file 24 and design information file 26 generated simultaneously with this dedicated ROM compiler 22.

A file set 20 (dedicated ROM compiler 22, intermediate file 28, correct ROM code file 44, and design information file 46) generated as described above is delivered via the network to workstation WS corresponding to an input source of design parameter 32. This file set 20 is typically delivered to workstation WS provided at the design department of the chip manufacturer and/or workstation WS provided on the customer side.

In workstation WS provided at the design department of the chip manufacturer, sign-off verification, layout verification and the like are carried out based on design information file 46 delivered from host server SRV.

On the other hand, in workstation WS provided on the customer side, dedicated ROM compiler 22 is executed and the contents of design information file 46 are changed to the contents corresponding to the correct ROM code. In other words, workstation WS executes dedicated ROM compiler 22, whereby workstation WS accepts correct ROM code 42, and changes design information file 26 corresponding to the temporary ROM code received from host server SRV to design information file 46 corresponding to correct ROM code 42 and outputs design information file 46. At this time, workstation WS executing dedicated ROM compiler 22 may output correct ROM code file 44 simultaneously.

When temporary ROM code file 24 and design information file 26 associated with dedicated ROM compiler 22 are not present, workstation WS executing this dedicated ROM compiler 22 prohibits generation of design information file 46 as described above. In other words, dedicated ROM compiler 22 is specifically designed to be capable of changing only particular design parameter 32 and design information file 26 associated with the temporary ROM code (the contents of temporary ROM code file 24). It should be noted that workstation WS executing dedicated ROM compiler 22 identifies design information file 26 of interest by referring to the identification information included in intermediate file 28 provided to dedicated ROM compiler 22 being executed. With such specifically designing processing, generation of design information file 46 based on different parameters, different versions and different correct ROM codes can be avoided.

As a typical technique for such specifically designing, the identification information included in intermediate file 28 as described above is used in the system according to the present embodiment. More specifically, a list of the module name(s) associated with corresponding dedicated ROM compiler 22 is described in intermediate file 28. Temporary ROM code file 24 and design information file 26 also have module names at the time of generation, respectively. It should be noted that these module names are preferably unique values in the system according to the present embodiment. When workstation WS executes dedicated ROM compiler 22, corresponding intermediate file 28 is first referred to and it is determined whether or not temporary ROM code file 24 and design information file 26 corresponding to the module names described therein are present. Only when both files are present, processing of accepting correct ROM code 42 and processing of generating design information file 46 as described above can be performed.

<Information Security>

As described above, dedicated ROM compiler 22 is delivered to each workstation WS separately from ROM compiler 10 installed on host server SRV, whereby the capability to secure information can be strengthened. As a more specific form, host server SRV may be provided on the vendor side instead of on the chip manufacturer side. The correct ROM code is preferably stored on the customer side or in a secure region on the chip manufacturer side.

In other words, the location where ROM compiler 10 is stored is physically isolated from the location where the correct ROM code is stored, whereby the capability to secure information of the correct ROM code can be strengthened.

<Functional Block Diagram>

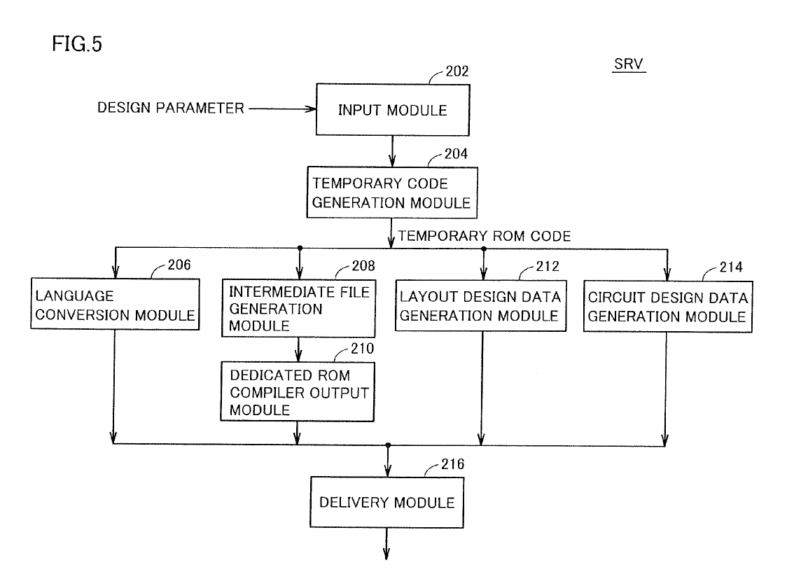

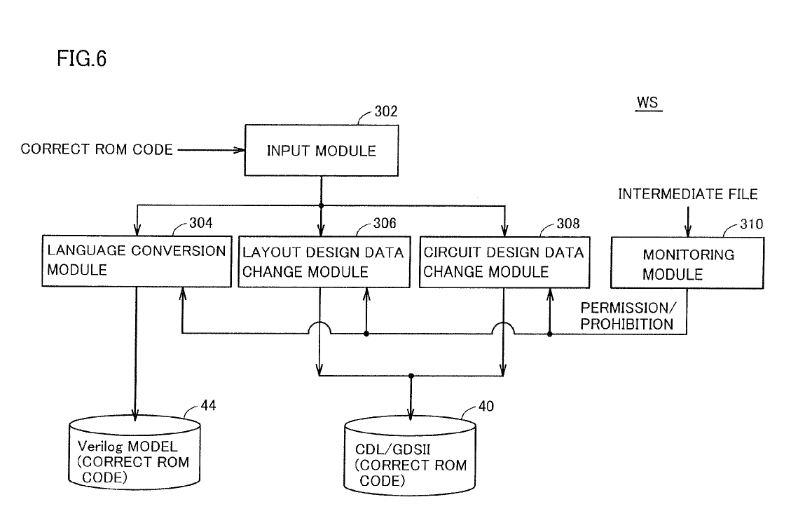

FIG. 5 is a functional block diagram of host server SRV according to the embodiment of the present invention. FIG. 6 is a functional block diagram of workstation WS according to the embodiment of the present invention.

Referring to FIG. 5, host server SRV includes, as a control structure thereof, an input module 202, a temporary code generation module 204, a language conversion module 206, an intermediate file generation module 208, a dedicated ROM compiler output module 210, a layout design data generation module 212, a circuit design data generation module 214, and a delivery module 216.

Input module 202 accepts a design parameter for a mask ROM to be manufactured, such as the ROM type (kind) and the number of Words/Bits.

Temporary code generation module 204 randomly determines an ROM code corresponding to the design parameter set via input module 202, and outputs the ROM code as a temporary ROM code.

Language conversion module 206 converts the temporary ROM code generated by temporary code generation module 204 to data described by the hardware description language (Verilog HDL), and outputs the data to delivery module 216 as a temporary ROM code file.

Intermediate file generation module 208 generates an intermediate file including identification information such as a module name provided to temporary ROM code file 24. Dedicated ROM compiler output module 210 outputs, to delivery module 216, a dedicated ROM compiler to which the intermediate file generated by intermediate file generation module 208 is provided.

Layout design data generation module 212 generates layout design data corresponding to the temporary ROM code generated by temporary code generation module 204, and outputs the layout design data to delivery module 216. Circuit design data generation module 214 generates circuit design data corresponding to the temporary ROM code generated by temporary code generation module 204, and outputs the circuit design data to delivery module 216.

In response to a request from either workstation WS, delivery module 216 delivers the temporary ROM code file, the dedicated ROM compiler, the intermediate file, the layout design data, and the circuit design data generated by the respective units as described above.

Workstation WS executes the dedicated ROM compiler delivered from host server SRV, thereby implementing a control structure as shown in FIG. 6. Referring to FIG. 6, workstation WS includes, as the control structure thereof, an input module 302, a language conversion module 304, a layout design data change module 306, a circuit design data change module 308, and a monitoring module 310.

Input module 302 accepts a correct ROM code to be stored in the mask ROM to be manufactured.

Language conversion module 304 converts the correct ROM code inputted via input module 302 to data described by the hardware description language (Verilog HDL), and outputs the data as a correct ROM code file.

Layout design data change module 306 generates layout design data corresponding to the correct ROM code by changing the layout design data received from host server SRV in accordance with the correct ROM code inputted via input module 302. Similarly, circuit design data change module 308 generates circuit design data corresponding to the correct ROM code by changing the circuit design data received from host server SRV in accordance with the correct ROM code inputted via input module 302.

Monitoring module 310 monitors the presence of the temporary ROM code file associated with the dedicated ROM compiler being executed in corresponding workstation WS and a design information file (the layout design data and the circuit design data) corresponding to this temporary ROM code. When either file is not present, monitoring module 310 prohibits generation processing in language conversion module 304, layout design data change module 306 and circuit design data change module 308.

### <Processing Procedure>

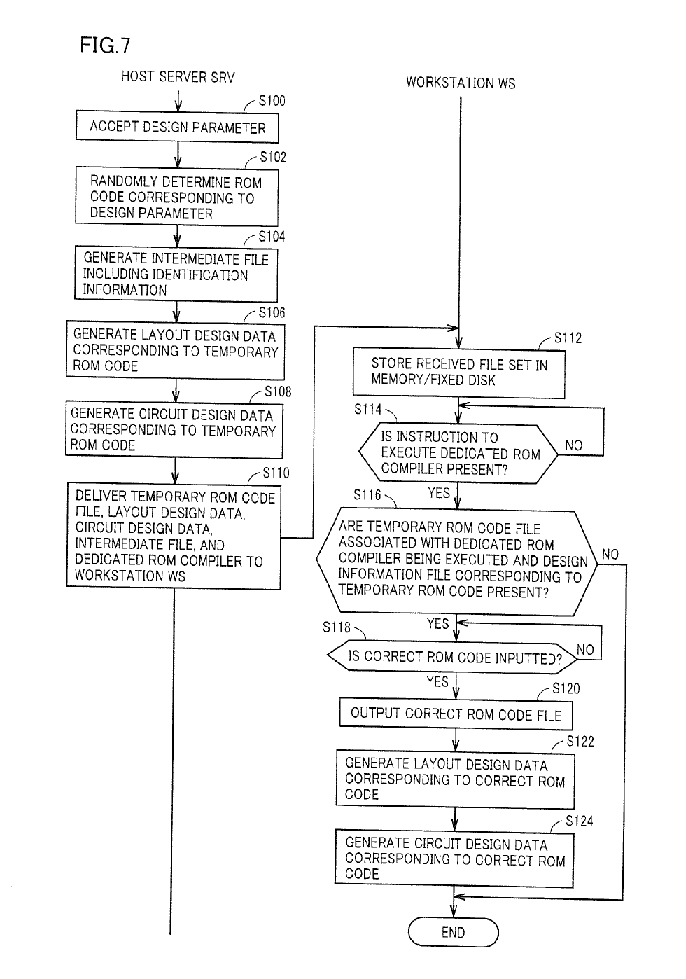

FIG. 7 is a flowchart showing a processing procedure in the system according to the embodiment of the present invention. Steps shown in FIG. 7 are performed by the CPU of host server SRV or workstation WS.

Referring to FIG. 7, CPU 105 of host server SRV accepts a design parameter for a mask ROM to be manufactured, such as the ROM type (kind) and the number of Words/Bits (step S 100). At this time, the user on the customer side or on the chip manufacturer side inputs a desired design parameter to host server SRV.

Then, CPU 105 of host server SRV randomly determines an ROM code corresponding to the inputted design parameter, and outputs the ROM code as a temporary ROM code file (step S102). At this time, CPU 105 of host server SRV preliminarily determines a module name provided to the temporary ROM code file. Furthermore, CPU 105 of host server SRV generates an intermediate file including identification information such as the module name provided to the temporary ROM code file (step S104).

In addition, CPU 105 of host server SRV generates layout design data corresponding to the temporary ROM code determined in step S102 (step S106) and generates circuit design data corresponding to the temporary ROM code (step S108).

Finally, CPU 105 of host server SRV delivers the temporary ROM code file generated in step S102, the layout design data generated in step S106, the circuit design data generated in step S 108, the intermediate file generated in step S104, and the dedicated ROM compiler to workstation WS (step S110).

Upon receiving the data set including the temporary ROM code file and the like from host server SRV, CPU 105 of workstation WS stores the data set in memory 106 or fixed disk 107 (step S112).

Then, CPU 105 of workstation WS determines whether or not execution of the dedicated ROM compiler is instructed (step S114). If execution of the dedicated ROM compiler is not instructed (NO in step S 114), the processing in step S114 is repeated.

On the other hand, if execution of the dedicated ROM compiler is instructed (YES in step S114), CPU 105 of workstation WS determines whether or not a temporary ROM code file associated with the dedicated ROM compiler being executed and a design information file (the layout design data and the circuit design data) corresponding to the temporary ROM code are present (step S116). If either the temporary ROM code file associated with the dedicated ROM compiler being executed or the design information file corresponding to this temporary ROM code is not present (NO in step S116), execution of the dedicated ROM compiler is discontinued.

In contrast, if both the temporary ROM code file associated with the dedicated ROM compiler being executed and the design information file corresponding to this temporary ROM code are present (YES in step S116), CPU 105 of workstation WS determines whether or not a correct ROM code is inputted (step S118). If the correct ROM code is not inputted (NO in step S118), the processing in step S118 is repeated.

In contrast, if the correct ROM code is inputted (YES in step S118), CPU 105 of workstation WS converts the inputted correct ROM code to data described by the hardware description language, and outputs the data as a correct ROM code file (step S120). Then, CPU 105 of workstation WS generates layout design data corresponding to the correct ROM code by changing the layout design data received from host server SRV in accordance with the inputted correct ROM code (step S122). CPU 105 of workstation WS also generates circuit design data corresponding to the correct ROM code by changing the circuit design data received from host server SRV in accordance with the inputted correct ROM code (step S124). Then, the processing ends.

### <Function and Effect>

According to the system in accordance with the embodiment of the present invention, the compiler generating the design information file corresponding to the correct ROM code is separated from the compiler generating the design information file corresponding to the design parameter for the mask ROM to be manufactured. In other words, developers other than the user having the correct ROM code can carry out a series of design and development without having access to the correct ROM code. Therefore, the capability to secure information of the correct ROM code can be strengthened.

In addition, according to the system in accordance with the embodiment of the present invention, even when the ROM code is changed, it is unnecessary to perform again the steps that have already been performed before the change. Therefore, the TAT at the time of the ROM code change can be shortened.

It should be understood that the embodiment disclosed herein is illustrative and not limitative in any respect. The scope of the present invention is defined by the terms of the claims, rather than the description above, and is intended to include any modifications within the scope and meaning equivalent to the terms of the claims.

### REFERENCE SIGNS LIST

10 ROM compiler; 20 file set; 22 dedicated ROM compiler; 24 correct ROM code file; 26 design information file; 28 intermediate file; 32 design parameter; 42 correct ROM code; 44 correct ROM code file; 46 design information file; 101 main body unit; 102 monitor; 103 keyboard; 104 mouse; 106 memory; 107 fixed disk; 109 communication interface; 111 FD drive device; 113 CD-ROM drive device; 202 input module; 204 temporary code generation module; 206 language conversion module; 208 intermediate file generation module; 210 compiler output module; 212 layout design data generation module; 214 circuit design data generation module; 216 delivery module; 302 input module; 304 language conversion module; 306 layout design data change module; 308 circuit design data change module; 310 monitoring module; LIB component library; NW network; SRV host server; WS, WS1, WS2 workstation

1. A system for creating a layout pattern for manufacturing a mask ROM, comprising:
a first information processing device; and
a second information processing device,
said first information processing device including:
a module for accepting a design parameter for the mask ROM to be manufactured;
a module for generating a first code; said first code being determined independently of a second code stored in said mask ROM to be manufactured,
a module for generating first design information corresponding to said first code; and
a module for outputting a program file having a command stored therein, said program file including identification information indicating association of said program file with said first code and said first design information,
said second information processing device being configured, when executing said command stored in said program file, to include:
a module for accepting said second code;
a module for generating second design information corresponding to said second code, based on said first code and said first design information; and
a module for prohibiting generation of said second design information when said first code and said first design information associated with said program file are not present based on said identification information.

2. The system according to claim 1, wherein
said module for generating said first code is adapted to determine said first code randomly.

3. The system according to claim 1, wherein
said first information processing device and said second information processing device are connected via a network to allow data communication, and
said first information processing device delivers said first code, said first design information and said program file to said second information processing device via the network.

4. A mask ROM manufactured using the system as recited in claim 1.

5. A method for creating a layout pattern for manufacturing a mask ROM using a system including a first information processing device and a second information processing device, the method comprising the steps of:
by said first information processing device, accepting a design parameter for the mask ROM to be manufactured;
by said first information processing device, generating a first code; said first code being determined independently of a second code stored in said mask ROM to be manufactured,
by said first information processing device, generating first design information corresponding to said first code;
by said first information processing device, outputting a program file having a command stored therein; said program file including identification information indicating association of said program file with said first code and said first design information,
by said second information processing device, executing said command stored in said program file;
by said second information processing device, accepting said second code;
by said second information processing device, generating second design information corresponding to said second code, based on said first code and said first design information; and
by said second information processing device, prohibiting generation of said second design information when said first code and said first design information associated with said program file are not present based on said identification information.
